(19) United States
(12) Patent Application Publication
(10) Pub. No.: US 2024/0223429 A1
(43) Pub. Date: Jul. 4, 2024

(54) COVERAGE ENHANCING DEVICES PROVIDING OFDM SYMBOL DELAYS

(71) Applicant: Sony Group Corporation, Tokyo (JP)

(72) Inventors: Kun ZHAO, Malmö (SE); Jose FLORDELIS, Lund (SE); Olof ZANDER, Södra Sandby (SE); Fredrik RUSEK, Eslöv (SE); Erik BENGTSSON, Eslöv (SE)

(21) Appl. No.: 18/289,068

(22) PCT Filed: May 5, 2022
(86) PCT No.: PCT/EP2022/062135

§ 371 Date: Oct. 31, 2023

(30) Foreign Application Priority Data
May 7, 2021 (SE) 2150584-7

(51) Int. Cl. H04L 27/26

(52) U.S. Cl. CPC H04L 27/26536

(57) ABSTRACT

According to a first aspect, examples provide a method of operating a first communication node (CN) wherein the first CN is configurable for transmitting, to a second CN on a radio channel, orthogonal frequency-division multiplexing (OFDM) symbols via a first propagation path and a second propagation path, wherein each OFDM symbol comprises a prefix, in particular a cyclic prefix, wherein transmitting the OFDM symbols via the first propagation path comprises transmitting the OFDM symbols to the second CN via a coverage enhancing device, wherein the method comprises providing, to the CED, a message indicative of a delay which is to be applied, by the CED, to incident signals, wherein the first CN selects the delay which is to be applied, by the CED, to the incident signals, to result in an arrival, at the second CN, of a first signal portion transmitted via the first propagation path of a first OFDM symbol being aligned with an arrival, at the second CN, of a second signal portion transmitted via the second propagation path of a second OFDM symbol. Further, a method of operating a second CN as well as a first CN and a second CN are provided.

### TECHNICAL FIELD

Various examples generally relate to communicating between nodes using coverage enhancing devices.

### BACKGROUND

In order to increase a coverage area for wireless communication, it is envisioned to use coverage enhancing devices (CEDs), particularly re-configurable relaying devices (RRD), more particularly, re-configurable reflective devices. Re-configurable reflective devices are sometimes also referred to as reflecting large intelligent surfaces (LISs). See, e.g., Sha Hu, Fredrik Rusek, and Ove Edfors. “Beyond massive MIMO: The potential of data transmission with large intelligent surfaces.” IEEE Transactions on Signal Processing 66.10 (2018): 2746-2758.

An RRD can be implemented by an array of antennas that can reflect incident electromagnetic waves/signals. The array of antennas can be semi-passive. Semi-passive can correspond to a scenario in which the antennas can impose a variable phase shift and typically provide no signal amplification. An input spatial direction from which incident signals on a radio channel are accepted and an output spatial direction into which the incident signals are reflected can be re-configured by changing a phase relationship between the antennas. Radio channel may refer to a radio channel specified by the 3GPP standard. In particular, the radio channel may refer to a physical radio channel. The radio channel may offer several time/frequency-resources for communication between different communication nodes of a communication system.

An access node (AN) may transmit signals to a wireless communication device (UE) via a CED. The CED may receive the incident signals from an input spatial direction and emit the incident signals in an output spatial direction to the UE. The AN may transmit the signals using a beam directed to the CED. In some scenarios, several CEDs may be used in parallel to transmit the signals from the AN to the UE. For example, a signal may be transmitted from the AN to the UE via a first propagation path and a second propagation path, wherein the first propagation path involves a reception and transmission of the signal by a first CED. The second propagation path may involve a reception and transmission of the signal by a second CED or may be a line-of-sight propagation path or may be a propagation path involving natural reflections.

Typically, orthogonal frequency-division multiplexing (OFDM) symbols are transmitted from the AN to the UE, wherein each OFDM symbol comprises a cyclic prefix. In some cases, the duration of a channel impulse response of the channel between the AN and the UE may be longer than the duration of the cyclic prefix of the OFDM symbols. This may lead to a loss of orthogonality among subcarriers of the OFDM symbols in case of a transmission of the OFDM symbols via a first propagation path and a second propagation path, wherein at least the transmission via the first propagation path involves a transmission via a CED.

### SUMMARY

Accordingly, there may be a need for further improving communication between nodes using coverage enhancing devices (CEDs).

Said need is addressed with the subject matter of the independent claims. The dependent claims describe further advantageous examples.

According to a first aspect, examples provide a method of operating a first communication node (CN) wherein the first CN is configurable for transmitting, to a second CN on a radio channel, orthogonal frequency-division multiplexing (OFDM) symbols via a first propagation path and a second propagation path, wherein each OFDM symbol comprises a prefix, in particular a cyclic prefix, wherein transmitting the OFDM symbols via the first propagation path comprises transmitting the OFDM symbols to the second CN via a coverage enhancing device, wherein the method comprises providing, to the CED, a message indicative of a delay which is to be applied, by the CED, to incident signals, wherein the first CN selects the delay which is to be applied, by the CED, to the incident signals, to result in an arrival, at the second CN, of a first signal portion transmitted via the first propagation path of a first OFDM symbol being aligned with an arrival, at the second CN, of a second signal portion transmitted via the second propagation path of a second OFDM symbol.

According to a second aspect, examples provide a method of operating a second CN, wherein the second CN is configurable for transmitting, to a first CN on a radio channel, OFDM symbols via a first propagation path and a second propagation path, wherein each OFDM symbol comprises a prefix, in particular a cyclic prefix, wherein transmitting the OFDM symbol via the first propagation path comprises transmitting the OFDM symbol to the first CN via a CED, wherein the method comprises obtaining, from the CED or the first CN, a message indicative of a delay which is to be applied, by the CED, to incident signals, wherein the delay which is to be applied, by the CED, to the incident signals, to result in an arrival, at the first CN, of a first signal portion transmitted via the first propagation path of a first OFDM symbol being aligned with an arrival, at the first CN, of a second signal portion transmitted via the second propagation path of a second OFDM symbol.

Further aspects provide examples of first CNs, second CNs and CED comprising control circuitry for performing respective methods.

### BRIEF DESCRIPTION OF THE DRAWINGS

FIG. 1 schematically illustrates a communication system according to various examples.

FIG. 2 schematically illustrates details of the communication system according to the example of FIG. 1.

FIG. 3 schematically illustrates multiple downlink transmit beams used at a transmitter node of the communication system and further schematically illustrates a CED towards which one of the multiple transmit beams is directed according to various examples.

FIG. 4 schematically illustrates details with respect to a CED.

FIG. 5 schematically illustrates a scenario for using CEDs.

FIG. 6 schematically illustrates a scenario for using CEDs.

FIG. 7 schematically illustrates a channel impulse response.

FIG. 8 schematically illustrates a channel impulse response.

FIG. 9 schematically illustrates a channel impulse response.

FIG. 10 schematically illustrates a two-tap channel.

FIG. 11 schematically illustrates portions of a received noise-free signal of the two-tap channel of FIG. 10.

FIG. 12 schematically illustrates a three-tap channel.

FIG. 13 schematically illustrates portions of a received noise-free signal of the three-tap channel of FIG. 12.

FIG. 14 schematically illustrates a three-tap channel.

FIG. 15 schematically illustrates portions of a received noise-free signal of the three-tap channel of FIG. 14.

FIG. 16 illustrates a step associated with an OFDM technique.

FIG. 17 illustrates a step associated with an OFDM technique.

FIG. 18 illustrates a step associated with an OFDM technique.

FIG. 19 illustrates a step associated with an OFDM technique.

FIG. 20 is a signaling diagram.

FIG. 21 is a signaling diagram.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Techniques are described that facilitate wireless communication between nodes. A wireless communication system includes a transmitter node and one or more receiver nodes. In some examples, the wireless communication system can be implemented by a wireless communication network, e.g., a radio-access network (RAN) of a Third Generation Partnership Project (3GPP)-specified cellular network (NW). In such case, the transmitter node can be implemented by an access node (AN), in particular a base station (BS), of the RAN, and the one or more receiver nodes can be implemented by terminals (also referred to as user equipment, UE). It would also be possible that the transmitter node is implemented by a UE and the one or more receiver nodes are implemented by one or more ANs and/or further UEs. Hereinafter, for the sake of simplicity, various examples will be described with respect to an example implementation of the transmitter node by an AN and the one or more receiver node by UEs—i.e., to downlink (DL) communication; but the respective techniques can be applied to other scenarios, e.g., uplink (UL) communication and/or sidelink communication.

### Communication Via CEDs

According to various examples, the transmitter node can communicate with at least one of the receiver nodes via one or more CEDs.

The CEDs may include an antenna array. The CEDs may include a meta-material surface. In examples, the CEDs may include a reflective antenna array (RAA).

There are many schools-of-thought for how CEDs should be integrated into 3GPP-standardized RANs.

In an exemplary case, the NW operator has deployed the CEDs and is, therefore, in full control of the CEDs' operations. The UEs, on the other hand, may not be aware of the presence of any CED, at least initially, i.e., it is transparent to a UE whether it communicates directly with the AN or via the CEDs. The CEDs essentially function as a coverage-extender of the AN. The AN may have established control links with the CEDs.

According to another exemplary case, it might be a private user or some public entity that deploys the CEDs. Further, it may be that the UE, in this case, controls the CEDs' operations. The AN, on the other hand, may not be aware of the presence of any CED and, moreover, may not have control over it/them whatsoever. The UE may gain awareness of the presence of a CED by means of some short-range radio technology, such as Bluetooth, wherein Bluetooth may refer to a standard according to IEEE 802.15, or WiFi, wherein WiFi may refer to a standard according to IEEE 802.11, by virtue of which it may establish the control link with the CED. It is also possible that the UE gains awareness of the presence of a CED using UWD (Ultra wideband) communication. Using UWB may offer better time resolution due to the wider bandwidth compared to other radio technologies.

The two exemplary cases described above are summarized in TAB. 1 below.

TABLE 1
Scenarios for CED integration into cellular NW

| Scenario | Description | Explanation |
|---|---|---|
| A | AN-CED | AN controls the CED and/or can obtain |
| | control link | information from the CED. A control link is |
| | | established between the AN and the CED. |
| B | UE-CED | UE controls the CED and/or can obtain |
| | control link | information from the CED. A control link is |
| | | established between the UE and the CED. |

Hereinafter, techniques will be described which facilitate communication between a transmitter node—e.g., an AN—and one or more receiver nodes—e.g., one or more UEs—using a CED.

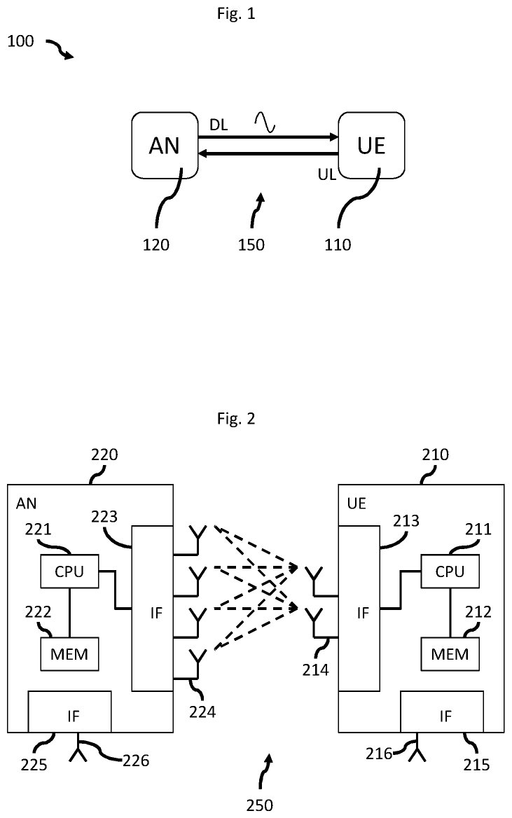

FIG. 1 schematically illustrates a communication system 100. The communication system 100 includes two nodes 110, 120 that are configured to communicate with each other via a radio channel 150. In the example of FIG. 1, the node 120 is implemented by an access node (AN) and the node 110 is implemented by a UE. The AN 120 can be part of a cellular NW (not shown in FIG. 1).

As a general rule, the techniques described herein could be used for various types of communication systems, e.g., also for peer-to-peer communication, etc. For the sake of simplicity, however, hereinafter, various techniques will be described in the context of a communication system that is implemented by an AN 120 of a cellular NW and a UE 110.

As illustrated in FIG. 1, there can be DL communication, as well as UL communication. Examples described herein particularly focus on the DL communication, but similar techniques may be applied to UL communication and/or sidelink communication. Input sweep and receive beam sweep may relate to DL communication and output sweep and transmit beam sweep may relate to UL communication.

FIG. 2 illustrates details with respect to the AN 220. The AN 220 includes control circuitry that is implemented by a processor 221 and a non-volatile memory 222. The processor 221 can load program code that is stored in the memory 222. The processor 221 can then execute the program code. Executing the program code causes the processor to perform techniques as described herein.

Moreover, FIG. 2 illustrates details with respect to the UE 210. The UE 210 includes control circuitry that is implemented by a processor 211 and a non-volatile memory 212. The processor 211 can load program code that is stored in the memory 212. The processor can execute the program code. Executing the program code causes the processor to perform techniques as described herein.

Further, FIG. 2 illustrates details with respect to communication between the AN 220 and the UE 210 on the radio channel 250. The AN 220 includes an interface 223 that can access and control multiple antennas 224. Likewise, the UE 210 includes an interface 213 that can access and control multiple antennas 214.

The UE 210 comprises a further interface 215 that can access and control at least one antenna 216 to transmit or receive a signal on an auxiliary radio channel different from the radio channel 250. Likewise, the AN 220 may comprise an additional interface 225 that can access and control at least one antenna 226 to transmit or receive a signal on the or a further auxiliary radio channel different from the radio channel. In general, the interface 225 may also be a wired interface. It may also be possible that the interface 225 is a wired or wireless optical interface. If wireless, the auxiliary radio channel may use in-band signaling or out-of-band signaling. The radio channel and the auxiliary radio channel may be offset in frequency. The auxiliary radio channel may be at least one of a Bluetooth radio channel, a WiFi channel, or an ultra-wideband radio channel. Methods for determining an angle of arrival may be provided by a communication protocol associated with the auxiliary radio channel. For example, methods for determining an angle of arrival may be provided by a Bluetooth radio channel.

While the scenario of FIG. 2 illustrates the antennas 224, 226 being coupled to the AN 220, as a general rule, it would be possible to employ transmit-receive points (TRPs) that are spaced apart from the AN 220.

The interfaces 213, 223 can each include one or more transmitter (TX) chains and one or more receiver (RX) chains. For instance, such RX chains can include low noise amplifiers, analogue to digital converters, mixers, etc. Analogue and/or digital beamforming would be possible.

Thereby, phase-coherent transmitting and/or receiving (communicating) can be implemented across the multiple antennas 214, 224. Thereby, the AN 220 and the UE 210 can selectively transmit on multiple TX beams (beamforming), to thereby direct energy into distinct spatial directions.

By using a TX beam, the direction of the wavefront of signals transmitted by a transmitter of the communication system is controlled. Energy is focused into a respective direction or even multiple directions, by phase-coherent superposition of the individual signals originating from each antenna 214, 224. Energy may also be focused to a specific point (or small sphere) at a specific direction and a specific distance of the transmitter. Thereby, a data stream may be directed in multiple spatial directions and/or to multiple specific points. The data streams transmitted on multiple beams can be independent, resulting in spatial multiplexing multi-antenna transmission; or dependent on each other, e.g., redundant, resulting in diversity multi-input multi-output (MIMO) transmission.

As a general rule, alternatively or additionally to such TX beams, it is possible to employ receive (RX) beams.

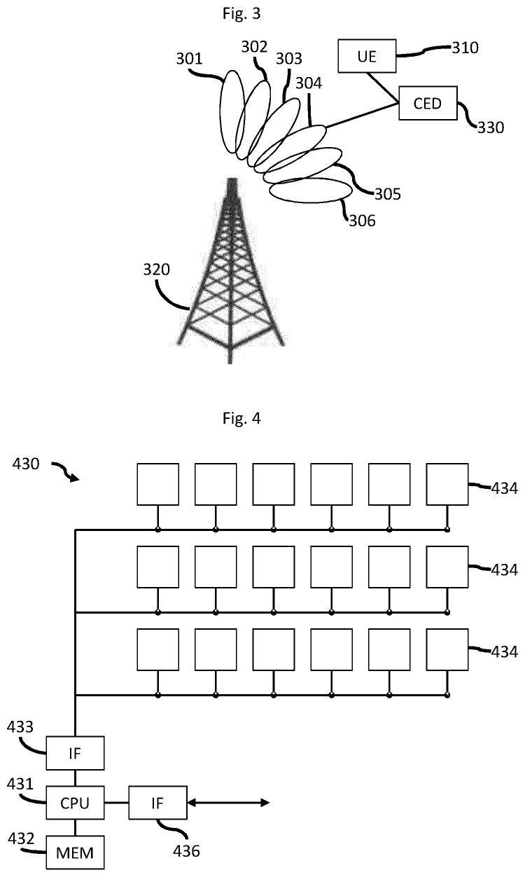

FIG. 3 illustrates DL TX beams 301-306 used by the AN 320. Here, the AN 320 activates the beams 301-306 on different resources (e.g., different time-frequency resources, and/or using orthogonal codes/precoding) such that the UE 310 can monitor for respective signals transmitted on the DL TX beams 301-306.

It is possible that the AN 320 transmits signals to the UE 310 via a CED 330. In the scenario of FIG. 3, the downlink transmit beam 304 is directed towards the CED 330. Thus, whenever the AN 320 transmits signals to the UE 310 using the downlink transmit beam 304—e.g., a respective block of a burst transmission—, a spatial filter is provided by the CED 330. The spatial filter is associated with a respective spatial direction into which the incident signals are then selectively reflected by the CED 330. Details with respect to the CED 330 are illustrated in connection with FIG. 4.

FIG. 4 illustrates aspects in connection with the CED 430. The CED 430 includes a phased array of antennas 434 that impose a configurable phase shift when reflecting incident signals. This defines respective spatial filters that may be associated with spatial directions into which the incident signals are reflected. The antennas 434 can be passive or semi-passive elements. The CED 430 thus provides coverage extension by reflection of radio-frequency (RF) signals. A translation to the baseband may not be required. This is different to, e.g., decode-and-forward repeater or regenerative functionality. The antennas 434 may induce an amplitude shift by attenuation. In some examples, the antennas 434 may provide forward amplification with or without translation of signals transmitted on the radio channel to the baseband. In some examples, the CEDs may be configurable to shift power from one polarization to the orthogonal polarization. The antennas 434 may amplify and forward the signals.

The CED 430 includes an antenna interface 433 which controls an array of antennas 434; a processor 431 can activate respective spatial filters one after another. The CED 430 further includes an interface 436 for receiving and/or transmitting signals on an auxiliary radio channel. The interface 436 may be a wireless interface. In some examples, the auxiliary radio channel may be replaced with a wired auxiliary channel and the interface 436 may be a wired interface. There is a memory 432 and the processor 431 can load program code from the non-volatile memory and execute the program code. Executing the program code causes the processor to perform techniques as described herein.

FIG. 4 is only one example implementation of a CED. Other implementations are conceivable. For example, a meta-material surface not including distinct antenna elements may be used. The meta-material can have a configurable refraction index. To provide a re-configurable refraction index, the meta-material may be made of repetitive tunable structures that have extensions smaller than the wavelength of the incident RF signals.

### Transmitting Signals on a Radio Channel Via Two or More Coverage Enhancing Devices (CEDs)

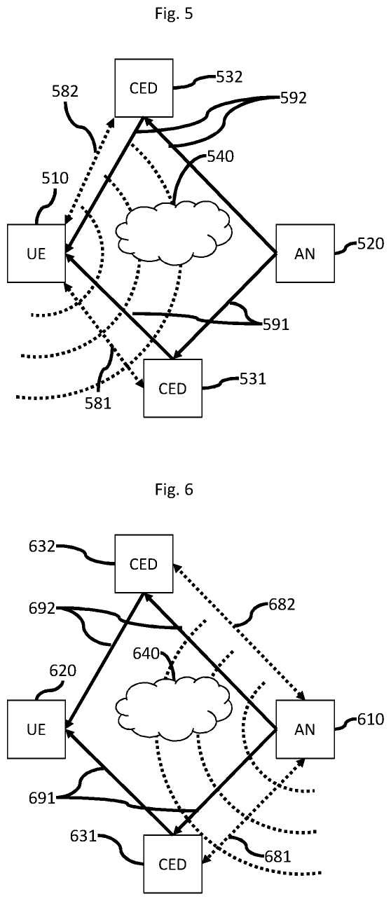

FIG. 5 illustrates an exemplary scenario B as described hereinbefore with reference to TAB. 1. A UE 510 is to communicate with an AN 520 over a radio channel via a first propagation path 591. The radio channel may be a 5G NR channel, in particular, a 5G NR channel in Frequency Range 2 or beyond. It is also conceivable that the radio channel is a 3GPP channel belonging to the frequency range from 7 to 24 GHz. An obstacle 540 between the UE 510 and the AN 520 may impede a direct line-of-sight communication between the UE 510 and the AN 520 on the radio channel.

A CED 531 may be employed to provide a physical propagation path 591 for the communication over the radio channel. In some examples, the position and orientation of the CED 531 with respect to the AN 520 may be fixed and known to the CED 531. As described hereinbefore, the CED 531 may be semi-passive and free of circuitry for encoding and decoding signals transmitted over the radio channel.

The CED 531 may provide multiple spatial filters, wherein each one of the multiple spatial filters is associated with a respective input spatial direction from which incident signals on a radio channel are accepted and with a respective output spatial direction into which the incident signals are reflected by the CED.

The CED 531 may perform an output sweep comprising changing the output spatial direction while using the given input spatial direction. In particular, the output sweep may be performed over signals transmitted by the AN 520. For example, the CED 531 can toggle through different output spatial directions by changing the phase relationships between the antenna elements.

The AN may send reference signals at certain times to the CED which emits the reference signals in different output spatial directions. During the beam sweep, the incident signals accepted by the CED are typically not emitted in an output spatial direction to the UE. In case the UE receives the reference signal, the reception properties determined by the UE may be used to re-configure the CED.

A further CED 532 may be employed to provide an additional (second) physical propagation path 592 for the communication over the radio channel. Both the first CED 531 and the second CED 532 may be controlled by the UE 510 via signaling 581 and 582, respectively.

In case of different propagation path lengths of the first propagation path and the second propagation path, the signal portions propagating via the first propagation path 591 and the second propagation path 592 may not necessarily interfere constructively and the improved coverage associated with the combined surfaces of the first CED 531 and the second CED 532 may not be obtained to the full extent. There may be at least some phase incoherence between the signal portions. FIG. 5 is an example of first communication node, CN, controlling the CEDs, wherein the first CN is receiving signals on the radio channel transmitted by a second communication node via the first propagation path and the second propagation path. In the example, the first CN is implemented by a UE and the second CN by an AN. However, it is also possible that the first CN is implemented by an AN and the second CN by a UE. In some scenarios, even both the first CN and the second CN may be implemented by UEs.

FIG. 6 illustrates an exemplary scenario A as described hereinbefore with reference to TAB. 1. An AN 610 is to communicate with a UE 620 over a radio channel via a first propagation path 691. The radio channel may be a 5G NR channel, in particular, a 5G NR channel in Frequency Range 2 or beyond. It is also conceivable that the radio channel is a 3GPP channel belonging to the frequency range from 7 to 24 GHz. An obstacle 640 between the UE 620 and the AN 610 may impede a direct line-of-sight communication between the UE 620 and the AN 610 over the radio channel.

A first CED 631 may be employed to provide a physical propagation path 691 for the communication over the radio channel. In some examples, the position and orientation of the first CED 631 with respect to the AN 610 may be fixed and known to the first CED 631. As described hereinbefore, the CED 631 may be semi-passive and free of circuitry for encoding and decoding signals transmitted over the radio channel.

The CED 631 may provide multiple spatial filters, wherein each one of the multiple spatial filters is associated with a respective input spatial direction from which incident signals on a radio channel are accepted and with a respective output spatial direction into which the incident signals are reflected by the first CED 631.

The CED 631 may perform an output sweep comprising changing the output spatial direction while using the given input spatial direction. In particular, the output sweep may be performed over signals transmitted by the AN 610. For example, the CED 631 can toggle through different output spatial directions by changing the phase relationships between the antenna elements.

The AN may send reference signals at certain times to the CED which emits the reference signals in different output spatial directions. During the beam sweep, the incident signals accepted by the CED are typically not emitted in an output spatial direction toward the UE. In case the UE receives the reference signal, the reception properties determined by the UE may be fed back to the AN and used to re-configure the CED.

A further CED 632 may be employed to provide an additional (second) physical propagation path 692 for the communication over the radio channel. Both the first CED 631 and the second CED 632 may be controlled by the AN 610 via signaling 681 and 682, respectively.

In case of different propagation path lengths of the first propagation path and the second propagation path, the signal portions propagating via the first propagation path 691 and the second propagation path 692 may not necessarily interfere constructively and the improved coverage associated with the combined surfaces of the first CED 631 and the second CED 632 may not be obtained to the full extent. There may be at least some phase incoherence between the signal portions. FIG. 6 is an example of first communication node, CN, controlling the CEDs, wherein the first CN is transmitting signals on the radio channel transmitted by a second communication node via the first propagation path and the second propagation path. In the example, the first CN is implemented by an AN and the second CN by a UE. However, it is also possible that the first CN is implemented by a UE and the second CN by an AN. In some scenarios, even both the first CN and the second CN may be implemented by UEs.

### Multipath Transmission of OFDM Symbols Involving CEDs

A first CN may transmit a signal s(t) to a second CN. In the absence of noise, the second CN may receive the signal r(t)=s(t)*h(t), wherein the operator * denotes the convolution and h(t) corresponds to the channel impulse response of the physical channel between the first CN and the second CN. If the transmitted signal s(t) corresponds to an OFDM symbol comprising a cyclic prefix, the duration tₕ of h(t) should be shorter than the duration t_{CP} of the cyclic prefix of the OFDM symbol as shown in FIG. 7.

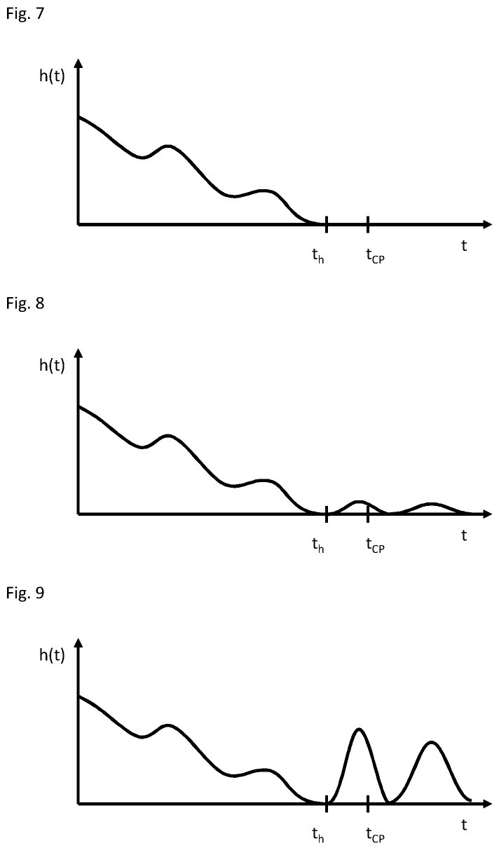

In practice, the condition h(t)=0 for t>t_{CP} is often only approximately fulfilled. As shown in FIG. 8, h(t) may still have small, almost negligible values h(t)=ε>0 for t>t_{CP}. However, these negligible values do not significantly degrade the system efficiency, so can be ignored.

In contrast, where a system includes a CED in, for example, the first propagation path, the CED may amplify h(t) for t>t_{CP} leading to h(t)>ε as shown in FIG. 9. Hence, the assumption h(t)≈0 for t>t_{CP} may no longer be valid and orthogonality among subcarriers used for transmitting the OFDM symbols may be lost. This may imply a significant degradation of the transmission performance.

Instead of extending the cyclic prefix, i.e., increasing t_{CP}, which may reduce spectral efficiency, the introduction of significant delays by the CED may surprisingly improve transmission performance.

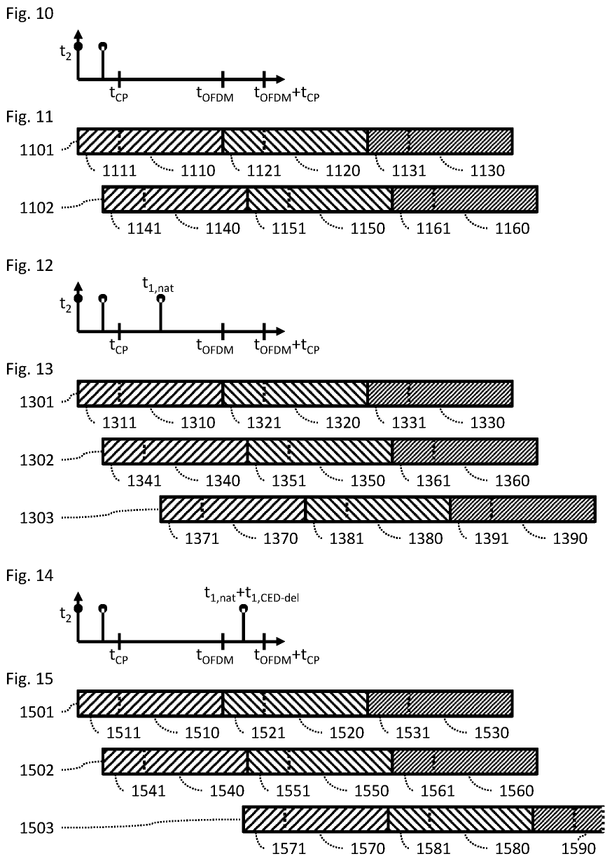

FIG. 10 shows a two-tap channel, more particularly the impulse response of the channel, between a first CN and a second CN that would emerge in the absence of a propagation path involving a CED. A two-tap channel is used to simplify the illustration, but similar considerations apply to channels comprising more taps. More generally, a channel impulse response can be represented by a discrete number of propagation delays, i.e., the channel taps, at which the energy of the channel is concentrated. In the example of FIG. 10, all taps of the channel are within t_{CP}.

FIG. 11 illustrates the received noise-free signal at the second CN. Since there is a two-tap channel, the received signal corresponds to an addition of the transmitted signal 1101 from the first CN comprising OFDM symbols 1110, 1120, 1130, wherein each OFDM symbol 1110, 1120, 1130 comprises a cyclic prefix 1111, 1121, 1131, and a delayed version 1102 thereof comprising OFDM symbols 1140, 1150, 1160. The delayed version of the OFDM symbols 1140, 1150, 1160 are delayed, for example, due to having arrived at the second CN along a different, longer propagation path than those of the non-delayed OFDM symbols 1110, 1120, 1130. As shown in FIG. 11, the OFDM symbols 1110, 1120, 1130 and 1140, 1150, 1160 are aligned, i.e., the OFDM symbol 1140, 1150, 1160 start within the duration t_{CP} of the respective cyclic prefix of the OFDM symbols 1110, 1120, 1130.

FIG. 12 shows the channel between the first CN and the second CN that emerges when a first propagation path via a CED is introduced and the CED amplifies a portion of the signal with a large delay t_{1,natural}. t_{1,natural} is solely a consequence of the propagation path length of the first propagation path. Due to the first propagation path, a three-tap channel emerges. Accordingly, the received signal corresponds to an addition of the transmitted signal 1301 comprising OFDM symbols 1310, 1320, 1330 with two delayed versions 1302, 1303 thereof comprising OFDM symbols 1340, 1350, 1360 and 1370, 1380, 1390, respectively, as shown in FIG. 13. The version delayed in view of the first propagation path arrives at the second CN with a delay exceeding t_{CP}. Hence, orthogonality among subcarriers is lost and the OFDM system breaks down.

FIG. 14 shows an example of the channel between the first CN and the second CN that emerges if the CED induces a further, intentional time delay t_{1,CED-delay}, which fulfils the equation

$$\vert \vert ( {t}_{1 , natural} + {t}_{1 , CED - delay} ) - {t}_{2} \vert - n \cdot {t}_{OFDM} \vert \leq {t}_{CP}$$

wherein t₂ corresponds to the propagation path not involving the CED, n is an integer equal or greater than 1 and t_{OFDM} corresponds to the duration of the OFDM symbols.

FIG. 15 illustrates the received noise-free signal at the second CN. Again, the received signal corresponds to an addition of the transmitted signal 1501 comprising OFDM symbols 1510, 1520, 1530 with two delayed versions 1502, 1503 thereof. The effect of adjusting the time delay t_{1,CED-delay} according to the aforementioned is that a first OFDM symbol, e.g. the OFDM symbol 1570, received via the first propagation path aligns with a second (not necessarily subsequent) OFDM symbol, e.g., the OFDM symbol 1520, received via the second propagation path. In particular, the start of the first OFDM symbol 1570 is comprised within the cyclic prefix of the second OFDM symbol 1520.

This may allow for processing and decoding of the received signals by the second CN using established processing techniques.

The intentional introduction of the delay t_{1,CED-delay} preserves orthogonality among the subcarriers. Signal portions assigned to subcarrier m remain in subcarrier m. Although orthogonality in time may be lost, established processing techniques may be used for demodulation. In particular, the preservation of orthogonality among subcarriers may allow for using low-complexity receivers.

For each demodulated OFDM symbol k, the value at subcarrier m is a linear combination of the value transmitted at subcarrier m in symbol k and the value transmitted at subcarrier m in symbol k−1, or, more generally, symbol k−j. In communication literature, this is known as a “two-tap time-discrete inter-symbol interference (ISI) channel”.

For OFDM symbol k and subcarrier m the following received value may be observed

$${r}_{k , m} = {H}_{k , m} {x}_{k , m} + {G}_{k - 1 , m} {x}_{k - 1 , m}$$

where x_{k,m} is the transmitted value at subcarrier m of OFDM symbol k, and where variables G and H represent the first propagation channel and the second propagation channel, respectively, between the first CN and the second CN. The first propagation channel involves a transmission via the CED and the second propagation channel may be a propagation channel not involving a transmission via a CED. In some examples described further below, the first propagation channel and the second propagation channel may be slow fading channels and, thus, G and H may be regarded as being time-invariant.

The complexity associated with the demodulation of an ISI channel depends on the length of the ISI channel, i.e. the number of interfering symbols. In the simplest case presented above, only two symbols interfere. For an ISI channel with length two and optimal maximum-likelihood decoding, the minimum distance (and therefore the bit error rate) may not differ for two-tap channels compared with the corresponding 1-tap channel of the same energy. Thus, two-tap channels may not degrade system performance.

Practical algorithms for demodulation of the arisen two-tap channel include: Maximum-Likelihood (ML) decoding; Maximum-A-Posteriori (MAP) decoding, linear equalizing algorithms such as Minimum-Mean-Square-Error (MMSE) algorithms or zero-forcing (ZF) algorithms; breadth first algorithms such as K-best algorithms and M-algorithms; the much celebrated Dual-Hellen receiver; decision-feedback algorithms; delayed-decision-feedback algorithms.

In the case of time-invariant H and G, the aforementioned formula reduces to

$${r}_{k , m} = {H}_{m} {x}_{k , m} + {G}_{m} {x}_{k - 1 , m} .$$

OFDM techniques may be used for communicating over such an ISI channel as an alternative to the demodulation techniques described above. Said OFDM techniques may be performed in addition to the established OFDM techniques specified for NR communication in 3GPP.

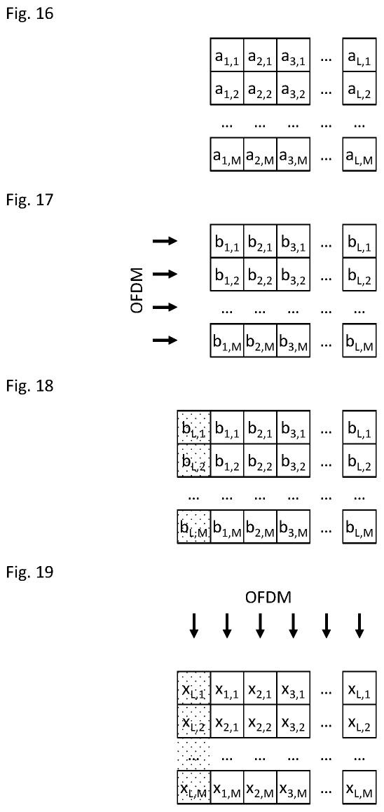

With reference to FIG. 16, L OFDM symbols may have to be transmitted from the first CN to the second CN. M subcarriers may be used for transmitting the L OFDM symbols.

All L data values per subcarrier may be collected into the vectors

$${a}_{m} = [ {a}_{1 , m} {a}_{2 , m} ... {a}_{L , m} ] .$$

Afterwards, M L-sized OFDM modulations are performed on the M vectors aₘ to obtain M L-sized modulated OFDM symbols bₘ (FIG. 17).

Afterwards one or more OFDM symbols may be added as a prefix, in particular as a cyclic prefix to the M L-size modulated OFDM symbols bₘ. For the two-tap ISI channel described hereinbefore, adding a single OFDM symbol as cyclic prefix may be sufficient (FIG. 18).

This results in L+1 OFDM symbols to be transmitted by the first CN to the second CN. Afterwards the established OFDM modulation as specified for NR communication in 3GPP may be performed for the L+1 symbols (FIG. 19).

The additional OFDM technique may restore orthogonality in time and may reduce the need for implementing special demodulation algorithms as listed above.

The proposed processing involves two OFDM modulations, one over time and one over frequency.

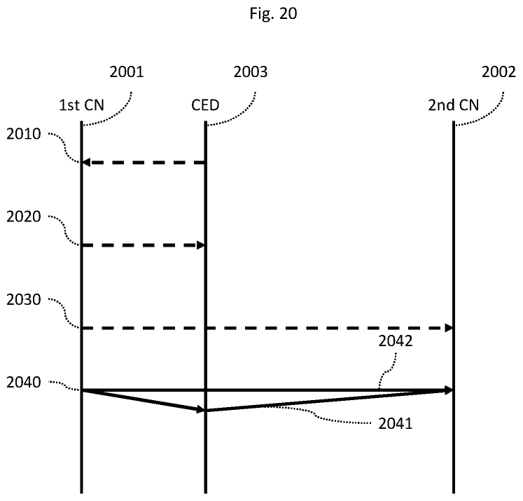

FIG. 20 is a signaling diagram illustrating signaling in a communication system comprising a first CN 2001, a second CN 2002 and a CED 2003. The first CN 2001 is configurable for transmitting, to the second CN 2002 on a radio channel, OFDM symbols via a first propagation path and a second propagation path, wherein each OFDM symbol comprises a prefix, in particular a cyclic prefix.

Transmitting the OFDM symbols to the second CN 2002 via the first propagation path comprises transmitting the OFDM symbols to the second CN 2002 via the CED 2003.

In examples, the CED 2003 may be reconfigurable to provide multiple spatial filterings, each one of the multiple spatial filterings being associated with a respective input spatial direction from which incident signals on a radio channel are accepted and with a respective output spatial direction into which the incident signals are transmitted by the CED 2003.

The first CN 2001 may obtain, from the CED 2003, a message 2010 indicative of a capability of the first CED 2003 to apply a delay to the incident signals.

The CED 2003 obtains, from the first CN 2001, a message 2020 indicative of a delay which is to be applied, by the CED 2003, to incident signals.

The first CN 2001 may select the delay which is to be applied, by the CED 2003, to the incident signals, to result in an arrival, at the second CN 2002, of a first signal portion transmitted via the first propagation path of a first OFDM symbol which is aligned with an arrival, at the second CN 2002, of a second signal portion transmitted via the second propagation path of a second OFDM symbol. The first CN 2001 may transmit the first OFDM symbol before the second OFDM symbol or vice versa. The first OFDM symbol and the second OFDM symbol may be consecutive symbols. However, it is also conceivable that the first CN 2001 transmits further OFDM symbols between the first OFDM symbol and the second OFDM symbol.

The first CN 2001 may also select the delay t_{1,CED-delay} which is to be applied to the incident signals, by the CED 2003, to result in a propagation time difference of a first propagation time t_{1,natural}+t_{1,CED-delay} associated with a propagation via the first propagation path and a second propagation time t₂ associated with a propagation via the second propagation path. An absolute value of a difference between an absolute value of said propagation time difference |(t_{1,natural}+t_{1,CED-delay})−t₂| and an integer multiple of one OFDM symbol duration t_{OFDM}, in particular one OFDM symbol duration t_{OFDM}, is less than or equal to one prefix duration t_{CP}. Thus, the delay t_{1,CED-delay} may be selected to comply with the equation:

$$\vert \vert ( {t}_{1 , natural} + {t}_{1 , CED - delay} ) - {t}_{2} \vert - n \cdot {t}_{OFDM} \vert \leq {t}_{CP}$$

where n is a positive integer. In other words, the CN 2001 may select the CED delay t_{1,CED-delay} so that the total spreading of the channel due to the first and the second propagation paths is smaller than the duration of the cyclic prefix, modulo the duration of an OFDM symbol.

The first CN 2001 may provide, to the second CN 2002, a message 2030 indicative of the delay to be applied by the CED 2003. For example, the message 2030 may indicate the propagation time difference |(t_{1,natural}+t_{1,CED-delay})−t₂| in units of OFDM symbol durations t_{OFDM}.

The first CN 2001 may perform OFDM techniques as described above with reference to FIGS. 16 to 19 to generate the OFDM symbols to be transmitted to the second CN 2002.

Finally, the first CN 2001 may transmit, to the second CN 2002 on the radio channel, OFDM symbols 2040, in particular OFDM symbols carrying payload data, via the first propagation path 2041 and the second propagation path 2042.

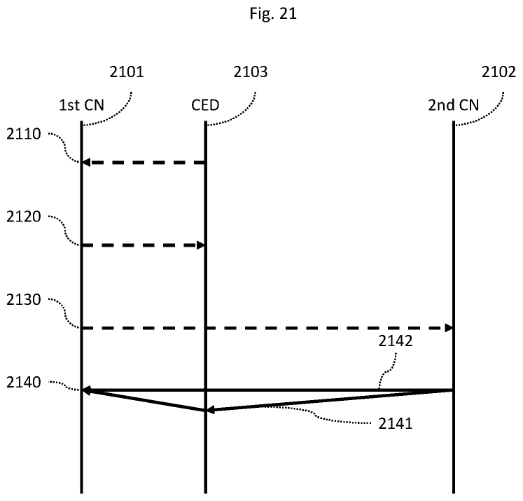

FIG. 21 is a further signaling diagram illustrating signaling in a communication system comprising a first CN 2101, a second CN 2102 and a CED 2103. In contrast to the signaling diagram of FIG. 20, the second CN 2102 is to transmit OFDM symbols to the first CN 2101.

In particular, the second CN 2102 is configurable for transmitting, to the first CN 2101 on a radio channel, OFDM symbols via a first propagation path and a second propagation path, wherein transmitting the OFDM symbols to the second CN 2102 via the first propagation path comprises transmitting the OFDM symbols to the first CN 2101 via the CED 2103.

In examples, the CED 2103 may be reconfigurable to provide multiple spatial filterings, each one of the multiple spatial filterings being associated with a respective input spatial direction from which incident signals on a radio channel are accepted and with a respective output spatial direction into which the incident signals are transmitted by the CED 2103.

The first CN 2101 may be configured for controlling the CED 2103. Accordingly, the first CN 2101 may obtain, from the CED 2103, a message 2110 indicative of a capability of the first CED 2103 to apply a delay to the incident signals and may provide, to the CED 2103, a message 2120 indicative of a delay which is to be applied, by the CED 2103, to incident signals.

The second CN 2102 may obtain, from the first CN 2101 or the CED 2103, a message 2130 indicative of the delay to be applied by the CED 2103. For example, the message 2130 may indicate the propagation time difference |(t_{1,natural}+t_{1,CED-delay})−t₂| associated with the first propagation path and the second propagation path in units of OFDM symbol durations t_{OFDM}.

The second CN 2101 may perform OFDM techniques as described above with reference to FIGS. 16 to 19 to generate the OFDM symbols to be transmitted to the first CN 2101.

Finally, the second CN 2101 may transmit, to the first CN 2101 on the radio channel, OFDM symbols 2140, in particular OFDM symbols carrying payload data, via the first propagation path 2141 and the second propagation path 2142.

Summarizing, at least the following EXAMPLES have been described above:

EXAMPLE 1. A method of operating a first communication node, CN,
wherein the first CN is configurable for transmitting, to a second CN on a radio channel, orthogonal frequency-division multiplexing, OFDM, symbols via a first propagation path and a second propagation path,
wherein each OFDM symbol comprises a prefix, in particular a cyclic prefix,
wherein transmitting the OFDM symbols via the first propagation path comprises transmitting the OFDM symbols to the second CN via a coverage enhancing device, CED, wherein the method comprises
   providing, to the CED, a message indicative of a delay which is to be applied, by the CED, to incident signals,
wherein the first CN selects the delay which is to be applied, by the CED, to the incident signals, to result in an arrival, at the second CN, of a first signal portion transmitted via the first propagation path of a first OFDM symbol which is aligned with an arrival, at the second CN, of a second signal portion transmitted via the second propagation path of a second OFDM symbol.

EXAMPLE 2. A method of operating a first communication node, CN, in particular, the method of operating the first CN of EXAMPLE 1,
wherein the first CN is configurable for transmitting, to a second CN on a radio channel, orthogonal frequency-division multiplexing, OFDM, symbols via a first propagation path and a second propagation path,
wherein each OFDM symbol comprises a prefix, in particular a cyclic prefix,
wherein transmitting the OFDM symbols via the first propagation path comprises transmitting the OFDM symbols to the second CN via a coverage enhancing device, CED, wherein the method comprises
   providing, to the CED, a message indicative of a delay which is to be applied, by the CED, to incident signals,
wherein the delay which is to be applied to the incident signals is selected to result in a propagation time difference of a first propagation time associated with a propagation via the first propagation path (t_{1,natural}+t_{1,CED-delay}) and a second propagation time (t₂) associated with a propagation via the second propagation path; wherein an absolute value of a difference of an absolute value of the propagation time difference and an integer multiple of one OFDM symbol duration (t_{OFDM}), in particular one OFDM symbol duration (t_{OFDM}), is less or equal than one prefix duration (t_{CP}).

EXAMPLE 3. The method of operating the first CN of EXAMPLE 1 or 2, further comprising
obtaining L OFDM symbols to be transmitted to the second CN using M subcarriers of the radio channel;
collecting all L data values per subcarrier into vectors xₘ, wherein 1≤m≤M;
performing M size-L OFDM modulations on the M vectors xₘ to obtain M L-size modulated OFDM symbols;
adding at least one OFDM symbol as a prefix, in particular as a cyclic prefix, to the M L-size modulated OFDM symbols;
transmitting, to the second CN on the radio channel, the resulting number of OFDM symbols.

EXAMPLE 4. The method of operating the first CN of any one of EXAMPLEs 1 to 3, further comprising
providing, to the second CN, a message indicative of the delay to be applied by the CED.

EXAMPLE 5. The method of operating the first CN of any one of EXAMPLEs 1 to 4, wherein the method further comprises
obtaining, from the CED, a message indicative of a capability of the first CED to apply a delay to the incident signals.

EXAMPLE 6. A method of operating a second communication node, CN,
wherein the second CN is configurable for transmitting, to a first CN on a radio channel, orthogonal frequency-division multiplexing, OFDM, symbols via a first propagation path and a second propagation path,
wherein each OFDM symbol comprises a prefix, in particular a cyclic prefix,
wherein transmitting the OFDM symbol via the first propagation path comprises transmitting the OFDM symbol to the first CN via a coverage enhancing device, CED, wherein the method comprises:
   obtaining, from the CED or the first CN, a message indicative of a delay which is to be applied, by the CED, to incident signals,
wherein the delay which is to be applied, by the CED, to the incident signals, to result in an arrival, at the first CN, of a first signal portion transmitted via the first propagation path of a first OFDM symbol which is aligned with an arrival, at the second CN, of a second signal portion transmitted via the second propagation path of a second OFDM symbol.

EXAMPLE 7. The method of operating the second CN of EXAMPLE 6,
wherein the delay which is to be applied to the incident signals results in a propagation time difference of a first propagation time associated with a propagation via the first propagation path (t_{1,natural}+t_{1,CED-delay}) and a second propagation time (t₂) associated with a propagation via the second propagation path;
wherein an absolute value of a difference of an absolute value of the propagation time difference and an integer multiple of one OFDM symbol duration (t_{OFDM}), in particular one OFDM symbol duration (t_{OFDM}), is less than or equal to one prefix duration (t_{CP}).

EXAMPLE 8. The method of operating the second CN of EXAMPLE 5, further comprising
obtaining L OFDM symbols to be transmitted to the first CN using M subcarriers of the radio channel;
collecting all L data values per subcarrier into vectors xₘ, wherein 1≤m≤M;
performing M OFDM modulation on the m vectors xₘ to obtain L OFDM symbols;
adding at least one OFDM symbol as a prefix, in particular as a cyclic prefix, to the L OFDM symbols;
transmitting, to the first CN on the radio channel, the resulting number of OFDM symbols.

EXAMPLE 9. A first communication node, CN,
wherein the first CN comprises control circuitry configured for performing the method of any one of EXAMPLEs 1 to 5.

EXAMPLE 10. A second communication node, CN,
wherein the second CN comprises control circuitry configured for performing the method of any one of EXAMPLEs 6 to 8.

1. A method of operating a first communication node (CN)
wherein the first CN is configurable for transmitting, to a second CN on a radio channel, orthogonal frequency-division multiplexing (OFDM) symbols via a first propagation path and a second propagation path,
wherein each OFDM symbol comprises a prefix, in particular a cyclic prefix,
wherein transmitting the OFDM symbols via the first propagation path comprises transmitting the OFDM symbols to the second CN via a coverage enhancing device (CED),
wherein the method comprises
providing, to the CED, a message indicative of a delay which is to be applied, by the CED, to incident signals,
wherein the first CN selects the delay which is to be applied, by the CED, to the incident signals, to result in an arrival, at the second CN, of a first signal portion transmitted via the first propagation path of a first OFDM symbol which is aligned with an arrival, at the second CN, of a second signal portion transmitted via the second propagation path of a second OFDM symbol.

2. The method of operating the first CN of claim 1,
wherein the delay which is to be applied to the incident signals is selected to result in a propagation time difference of a first propagation time associated with a propagation via the first propagation path (t_{1,natural}+t_{1,CED-delay}) and a second propagation time (t₂) associated with a propagation via the second propagation path;
wherein an absolute value of a difference between an absolute value of the propagation time difference and an integer multiple of one OFDM symbol duration (t_{OFDM}), in particular one OFDM symbol duration (t_{OFDM}), is less or equal than one prefix duration (t_{CP}).

3. The method of operating the first CN of claim 1, further comprising
obtaining L OFDM symbols to be transmitted to the second CN using M subcarriers of the radio channel;
collecting all L data values per subcarrier into vectors xₘ, wherein 1≤m≤M;
performing M L-sized OFDM modulations on the M vectors xₘ to obtain M L-sized modulated OFDM symbols;
adding at least one OFDM symbol as a prefix, in particular as a cyclic prefix, to the M L-size modulated OFDM symbols;
transmitting, to the second CN on the radio channel, the resulting number of OFDM symbols.

4. The method of operating the first CN of claim 1, further comprising
providing, to the second CN, a message indicative of the delay to be applied by the CED.

5. The method of operating the first CN of claim 1, wherein the method further comprises
obtaining, from the CED, a message indicative of a capability of the first CED to apply a delay to the incident signals.

6. A method of operating a second communication node (CN)
wherein the second CN is configurable for transmitting, to a first CN on a radio channel, orthogonal frequency-division multiplexing (OFDM) symbols via a first propagation path and a second propagation path,
wherein each OFDM symbol comprises a prefix, in particular a cyclic prefix,
wherein transmitting the OFDM symbol via the first propagation path comprises transmitting the OFDM symbol to the first CN via a coverage enhancing device (CED),
wherein the method comprises:
obtaining, from the CED or the first CN, a message indicative of a delay which is to be applied, by the CED, to incident signals,
wherein the delay which is to be applied, by the CED, to the incident signals, to result in an arrival, at the first CN, of a first signal portion transmitted via the first propagation path of a first OFDM symbol being aligned with an arrival, at the first CN, of a second signal portion transmitted via the second propagation path of a second OFDM symbol.

7. The method of operating the second CN of claim 6,
wherein the delay which is to be applied to the incident signals results in a propagation time difference of a first propagation time associated with a propagation via the first propagation path (t_{1,natural}+t_{1,CED-delay}) and a second propagation time (t₂) associated with a propagation via the second propagation path;
wherein an absolute value of a difference of an absolute value of the propagation time difference and an integer multiple of one OFDM symbol duration (t_{OFDM}), in particular one OFDM symbol duration (t_{OFDM}), is less or equal than one prefix duration (t_{CP}).

8. The method of operating the second CN of claim 6, further comprising
obtaining L OFDM symbols to be transmitted to the first CN using M subcarriers of the radio channel;
collecting all L data values per subcarrier into vectors xₘ, wherein 1≤m≤M;
performing M OFDM modulation on the m vectors xₘ to obtain L OFDM symbols;
adding at least one OFDM symbol as a prefix, in particular as a cyclic prefix, to the L OFDM symbols;
transmitting, to the first CN on the radio channel, the resulting number of OFDM symbols.

9. A first communication node (CN)
wherein the first CN comprises control circuitry configured for performing the method of claim 1.

10. A second communication node (CN)
wherein the second CN comprises control circuitry configured for performing the method of claim 6.
